(19) United States
(12) Patent Application Publication
(10) Pub. No.: US 2004/0140640 A1
(43) Pub. Date: Jul. 22, 2004

(54) Wheel suspension system for a motor vehicle

(76) Inventors: Michael Frantzen, Aachen (DE); Lauri Ohra-Aho, Aachen (DE); Wolfgang Risse, Hilden (DE); Edmund Halfmann, Neuss (DE); Paul Fickers, Heerlen (NL); Frank Rogowski, Bonn (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/735,372

(22) Filed: Dec. 15, 2003

(30) Foreign Application Priority Data
Dec. 13, 2002 (EP) 02102749.5

(51) Int. Cl. B60G 3/06; B60G 15/07; B60G 21/055

(52) U.S. Cl. 280/124.107; 280/124.145

(57) ABSTRACT

A wheel suspension system for a motor vehicle has a steering swivel (1) attached to a beam (3) so as to be rotatable about a vertical axis (6). The vertical axis (6) runs approximately through the center (Z) of the wheel. The beam (3) is additionally coupled at its lower end to the bodywork via a link (8), the link (8) being swivelably mounted on the bodywork. Instead of the steering swivel (1), it is also possible to mount a spindle so as to be rotatable about a vertical axis through the center of the wheel. The suspension leg (4) is secured against rotation by coupling to a stabilizer (20).

### FIELD OF THE INVENTION

The invention relates to a wheel suspension system for a motor vehicle containing a bearing element for the wheel axle; a beam on which the bearing element is mounted so as to be rotatable with respect to an essentially vertical axis, the vertical axis running near to the center of the wheel; a suspension leg which is connected to the beam and is supported on the bodywork; a link which is coupled to the bodywork and is connected to the beam or to the bearing element.

### BACKGROUND OF THE INVENTION

German patent publication DE 42 06 896 A1 discloses a wheel suspension system wherein a wheel of the motor vehicle is mounted with its axis of rotation on a steering swivel. The steering swivel is mounted on a beam so as to be rotatable about an essentially vertical axis, which beam is permanently connected to a suspension leg which is supported on the bodywork. In addition, the beam is swivelably coupled to a cross beam which is connected in articulated fashion to the bodywork. In order to stabilize the steering swivel and prevent undesired rotations of the suspension leg, the steering swivel is connected to the bodywork by means of a further link. In comparison with a conventional wheel suspension system of what is referred to as the McPherson type, in which the bearing element and the beam are permanently connected or integral, the described wheel suspension system requires additional constructional elements, especially articulation points on the bodywork.

German patent publication DE 44 09 571 A1 teaches a wheel suspension system wherein a suspension leg axle is based on the McPherson axle and has a steering swivel on which a wheel of the motor vehicle is mounted with its axis of rotation. The steering swivel is also coupled to the bodywork by means of a suspension leg composed of a damper piston and a helical spring as well as by means of a crosslink. In order to reduce the tendency of such a wheel suspension system to cause oscillations of the steering wheel and unsteady running, according to DE 44 09 571 A1 the damper cylinder is mounted in a nonrotational fashion by means of a link which is additionally attached to the cylinder and coupled to the bodywork.

### SUMMARY OF THE INVENTION

The wheel suspension system for a motor vehicle according to the invention contains a bearing element for the axis of rotation of the wheel which is to be suspended. The wheel may be a driven or nondriven front wheel or rear wheel of the motor vehicle. The bearing element may be in particular a steering swivel or a spindle. The latter is mounted on a beam so as to be rotatable with respect to an essentially vertical axis, the vertical axis running past the center of the wheel in close proximity. This is intended of course to include in particular the case in which the vertical axis runs through the center of the wheel. Through the rotatable mounting of the bearing element about the explained vertical axis, an additional degree of freedom is introduced in comparison with the conventional McPherson axle. The braking force lever as well as the acceleration force lever and the impact radius can thus be set as desired, these variables being preferably minimized. This minimizes the generation and transmission of disruptive oscillations and forces.

In addition, the beam is coupled to the bodywork directly or indirectly by means of a suspension leg. The suspension leg may be composed in a known fashion of a damper piston and a helical compression spring and ensures damped, elastic support of the wheel on the bodywork.

The wheel suspension system also has a link which is coupled at one end to the bodywork of a motor vehicle. The link can be attached to the bodywork by at least one hinged joint so that the latter can rotate only about one axis. At its other end, the link is coupled, in a first variant of the invention, to the abovementioned beam in an articulated fashion. In a second variant of the invention, the link is coupled at its second end to the bearing element in an articulated fashion.

In the two abovementioned variants of the wheel suspension system, the suspension leg and/or the beam is coupled to a stabilizer. Stabilizers are used in the automobile industry as spring elements for improving the road holding of a motor vehicle. Frequently, stabilizers are embodied in this context as a round stabilizer rods whose central part is rotatably attached to the bodywork, while the ends are attached to the wheel suspension systems (in particular the crosslinks) of the wheels by means of rubber elements. When a wheel is lifted up (spring compression), the other wheel is also lifted up through rotation of the stabilizer. When cornering, this effect counteracts excessive lateral incline of the bodywork.

As a result of the coupling between the suspension leg/beam and the stabilizer it is possible to stabilize the suspension leg against rotations when forces occur in the longitudinal direction or transverse direction without further links on the beam and/or on the bearing element being required for this. For this reason, the wheel suspension system can use the same articulation points on the bodywork—i.e. one support for the suspension leg and one swivelable bearing for the (cross)link—as a conventional McPherson axle. This makes it possible to use both types of wheel suspension optionally on the same type of vehicle, and in this way provide, for example, a more cost-effective and better quality variant of the vehicle.

There are various possible ways of configuring the connection between the stabilizer and suspension leg/beam. In particular, the stabilizer can be coupled to the suspension leg or beam via an elastic bearing such as, for example, a rubber bearing or by means of a ball-and-socket joint. The aforesaid types of joint have the advantage that they are cost-effectively available.

The link can be attached to the beam (first variant of the invention) or to the bearing element (second variant of the invention) by means of a hinged joint. This has the advantage of reinforcing the subsequent construction of the wheel suspension system. When the link is coupled to the beam, the reinforcement also acts on the suspension leg which is connected to the beam so that its rotation is prevented. The disadvantage of coupling by means of a hinged joint is however that the suspension leg must lie in a plane perpendicularly to the swivel axis of the link (with respect to the bodywork) so that movement in this configuration is kinematically possible. However, this restricts the design possibilities of the wheel suspension system considerably so that in many cases it is no longer possible to replace it with a conventional McPherson axle. Furthermore, the spring behavior of the motor vehicle is unfavorably influenced under certain circumstances by the prescribed orientation of the suspension leg.

For this reason, according to one preferred development of the invention the link is attached to the beam (first variant of the invention) or to the bearing element (second variant of the invention) by means of a ball-and-socket joint. Ball-and-socket joints are on the one hand cost-effectively available, and on the other hand permit a relative movement between the coupled elements about any desired axis. As a result, the kinematic restriction that the suspension leg has to lie perpendicularly with respect to the swivel axis of the link is eliminated so that it can also be arranged in other orientations. The fact that the wheel suspension system can be freely interchanged with a standard McPherson axle is thus ensured in all cases. Despite the additional degree of freedom of the ball-and-socket joint, the suspension leg does not rotate as it is prevented from doing so by the stabilizer.

The suspension leg is optionally arranged in a position which is tilted with respect to the vertical. Such tilting is in particular possible with the use of a ball-and-socket joint between the link and beam or between the link and bearing element, as described above. The suspension leg can preferably be inclined backwards even with respect to the direction of travel in order to improve the anti-dive control of the suspension.

Furthermore, the suspension leg is preferably oriented in such a way that it lies in the same plane as the steering axis. As a result, the space which is available for the steering movement can be maximized.

### BRIEF DESCRIPTION OF THE DRAWINGS

The invention is explained by way of example in more detail below using the figures, of which

FIG. 1 is a schematic side view of a first variant of a wheel suspension system according to the invention;

FIG. 2 is a more detailed perspective view of the wheel suspension system according to FIG. 1;

FIG. 3 is a perspective view of a refinement with a stabilizer coupled to the beam;

FIG. 4 shows part of a wheel suspension system according to the invention with a spindle;

FIG. 5 s hows a perspective view of a second variant of a wheel suspension system according to the invention.

### DETAILED DESCRIPTION OF THE PREFERRED EMBODIMENTS

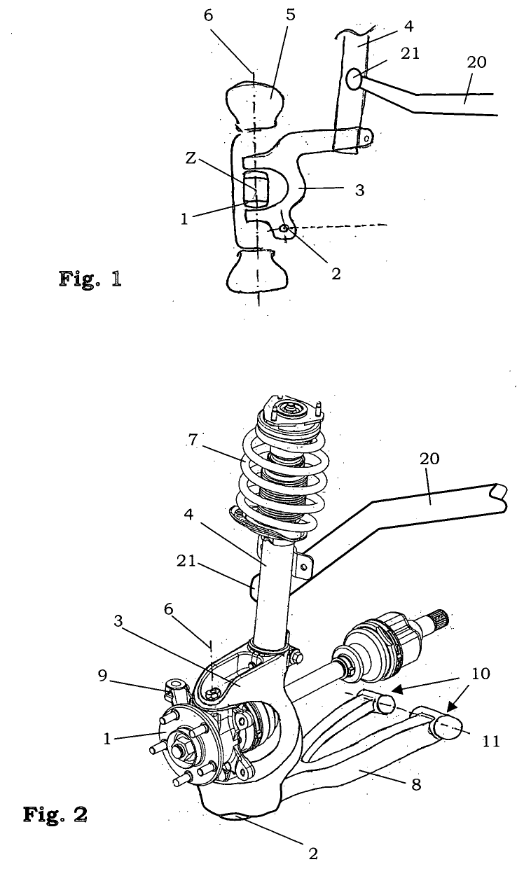

FIG. 1 shows a schematic side view of a wheel suspension system according to the invention which is based in its design on what is referred to as the McPherson axle. The latter is a single-wheel suspension system in which a steering swivel is mounted at the bottom on a crosslink which is swivelably mounted on the bodywork and at the top on an oscillation damper tube (“McPherson suspension leg”). The oscillation damper tube thus replaces the upper crosslink of a double crosslink axle (cf. “Fachkunde Krafffahrzeugtechnik [Motor vehicle technology]” 26^{th} edition, Verlag Europa Lehrmittel, Haan-Gruiten, chapter 4.5.3). The crosslink is preferably supported on the bodywork in a hinged joint, or in two hinge joints in the case of a triangular crosslink. The oscillation damper tube is preferably mounted on the bodywork in an elastic rubber bearing.

A wheel 5 of the motor vehicle is connected to the bodywork (not illustrated) by means of the wheel suspension system. The wheel 5 is mounted here so as to be rotatable about its horizontal axis of rotation on a steering swivel 1 as bearing element. The steering swivel 1 is itself mounted in a fork-shaped beam 3 so as to be capable of rotating about a vertical axis 6. The vertical axis 6 runs through the center Z of the wheel 5 or past it in close proximity. Its distance from the center is preferably less than 80%, particularly preferably less than 20% of the width of the wheel or rim. This rotational support of the steering swivel 1 shortens lever distances which give rise to the transmission of disruptive forces to the steering system in conventional wheel steering systems.

The beam 3 is coupled at its upper end to the bodywork via the damper piston 4 of a suspension leg. Furthermore, it is connected to the bodywork at its lower end in a cost-effective standard ball-and-socket joint 2 by means of the fork-shaped link 8 (FIG. 2), the link 8 being itself attached to the bodywork in two hinged joints 10 so as to rotate about an axis 11. This additional coupling of the beam 3 to the bodywork reduces its degrees of freedom, which gives rise to additional insulation and increased stiffness.

The swivel axis 11 of the link 8 is preferably essentially parallel to the longitudinal axis of the vehicle.

Furthermore, FIG. 1 shows an end section of a stabilizer 20 which is coupled to the suspension leg 4 in a rubber bearing or ball-and-socket joint 21. The stabilizer 20 has, in a known fashion, the basic function of coupling the wheels of the motor vehicle which are on the same axle to one another. In addition, the stabilizer ensures here that rotations of the suspension leg 4 are prevented if forces act on the beam 3 in the longitudinal or transverse direction. Without anti-rotation protection of the suspension leg 4, such forces would cause it to rotate as the beam 3 is connected to the link 8 (FIG. 2) in a ball-and-socket joint 2 which can rotate in any way.

FIG. 2 shows a perspective view of a possible refinement of the wheel suspension system described above. Here in particular it is possible to see the design of the suspension leg composed of the damper piston 4 and helical compression spring 7. In addition, a shoulder 9 to which a further link element or a track rod can be attached is shown on the steering swivel 1.

By using the ball-and-socket joint 2 between the link 8 and beam 3 it becomes possible to arrange the suspension leg 4 in relation to the bodywork in other planes than perpendicularly with respect to the swivel axis 11 of the link 8 while preserving the kinematic peripheral conditions. This freedom in the positioning of the suspension leg 4 can be used to improve the packing density of the design, the exchangeability with other types of wheel designs and the kinematics of the wheel suspension system. In particular, it is possible to arrange the suspension leg 4 inclined toward the rear in order to improve the anti-dive control behavior of the suspension system. In addition, the suspension leg can be arranged in the same way as in a conventional McPherson axle in order to adapt to the same articulation points and therefore permit an easier exchange. Finally, the freedom in the arrangement of the suspension leg can also be utilized to arrange the steering axle and the suspension leg in the same plane in order to maximize the space for the steering movement.

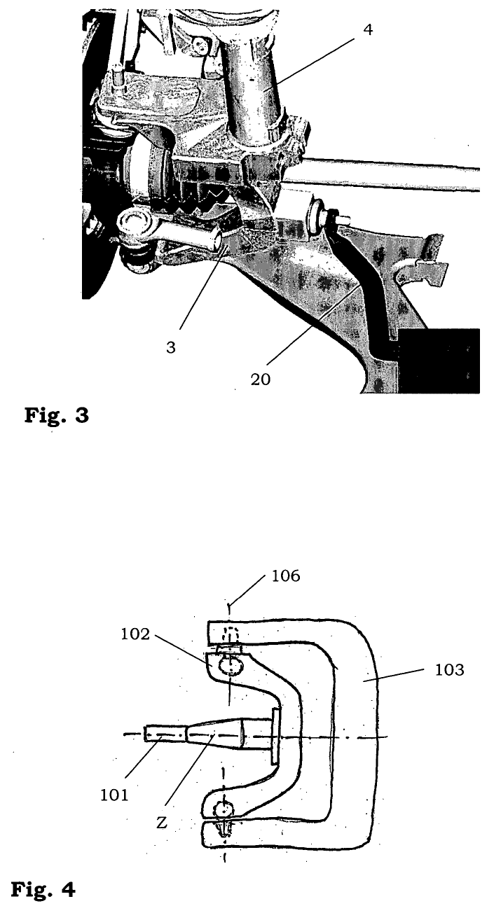

FIG. 3 shows in a perspective a modification of a wheel suspension system described above in which the stabilizer 20 is coupled to the beam 3 (instead of to the suspension leg 4).

FIG. 4 shows a detail of a wheel suspension system in which the wheel is not attached to a steering swivel but rather to a spindle 101. The spindle 101 is supported here by a U-shaped yoke 102 which is attached itself to a U-shaped beam 103 so as to be capable of rotating about the vertical axis 106. According to the invention, the vertical axis 106 in turn runs (approximately) through the center Z of the wheel suspension system.

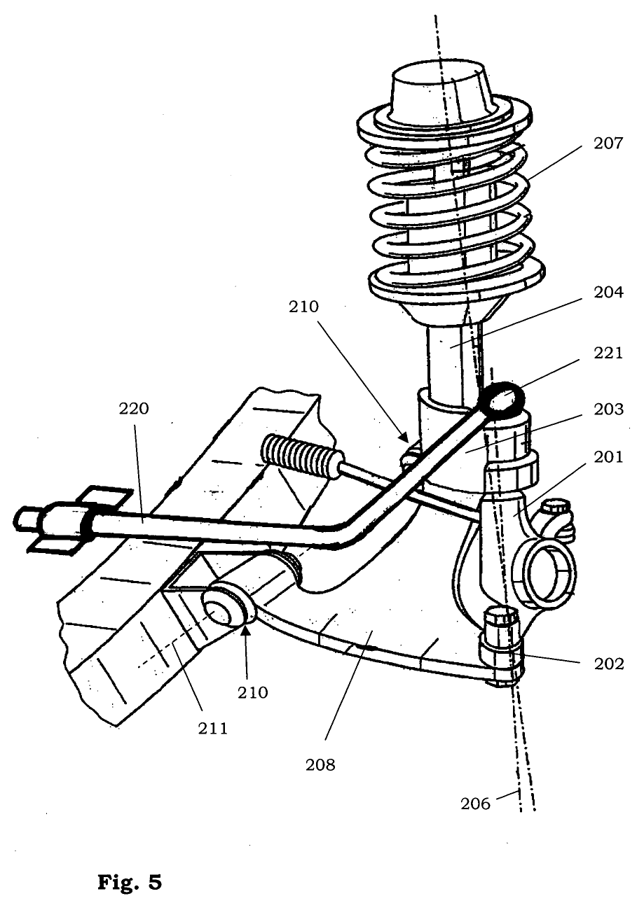

FIG. 5 shows a second variant of a wheel suspension system according to the invention which is based on a wheel suspension system according to DE 44 09 571 A1. Identical parts to those in FIGS. 1 and 2 are provided here with corresponding reference numbers increased by 200.

The wheel suspension system contains a steering swivel 201 as bearing element for a wheel (not illustrated) which is supported at its upper end on a beam 203 so as to be capable of rotating about a vertical axis 206. The beam 203 is itself connected to a suspension leg 204 which contains, inter alia, a helical spring 207.

Furthermore, a (cross)link 208 is mounted in two hinged joints 210 on the bodywork so as to be capable of swiveling about an axis 211. The other end of the link 208 is connected—in contrast to the first variant in FIGS. 1 to 4—to the bearing element 201 in a hinged joint 202, the hinge axis being aligned with the vertical axis 206. Instead of a hinged joint 201, it would also be possible to provide a cost-effective standard ball-and-socket joint.

In order to stabilize the suspension leg 204 against rotation, it is connected to a stabilizer 220 via a ball-and-socket joint 221. The necessity to attach an additional link to the suspension leg (cf. DE 44 09 571 A1) is thus eliminated, which makes the wheel suspension system compatible with one of the McPherson type.

The invention claimed is:

1. A wheel suspension system for a motor vehicle having bodywork, comprising:
a bearing element supporting a wheel;
a beam on which the bearing element is mounted such that the bearing element is rotatable with about an essentially vertical axis;
a suspension leg connected to the beam and supported on the bodywork;
a link coupled to the bodywork and connected to the beam; and
a stabilizer coupled to at least one of the suspension leg and the beam.

2. The wheel suspension system as claimed in claim 1, wherein the stabilizer is coupled to the at least one of the suspension leg and the beam by an elastic bearing.

3. The wheel suspension system as claimed in claim 1, wherein the stabilizer is coupled to the at least one of the suspension leg and the beam by a ball-and-socket joint.

4. The wheel suspension system as claimed in claim 1, wherein the link is attached to at least one of the beam and the bearing element by a ball-and-socket joint.

5. The wheel suspension system as claimed in claim 1, wherein the suspension leg is arranged in a position which is tilted with respect to vertical.

6. The wheel suspension system as claimed in claim 1, wherein the suspension leg lies in the same plane as the steering axis.

7. The wheel suspension system as claimed in claim 1, wherein the link is attached to the bodywork by at least one hinged joint.

8. The wheel suspension system as claimed in claim 1, wherein the bearing element comprises a steering swivel.

9. The wheel suspension system as claimed in claim 1, wherein the bearing element comprises a spindle.

10. The wheel suspension system as claimed in claim 1, wherein the suspension leg comprises a damper strut.

11. The wheel suspension system as claimed in claim 1, wherein the suspension leg comprises a helical coil.
